(19) United States
(12) Patent Application Publication
(10) Pub. No.: US 2019/0242504 A1
(43) Pub. Date: Aug. 8, 2019

(54) FUEL PIPE

(71) Applicant: LENTUS COMPOSITES LIMITED, Banbury Oxfordshire (GB)

(72) Inventors: Paul Lewis, Eynsham Oxfordshire (GB); Michael Dewhirst, Eynsham Oxfordshire (GB)

(21) Appl. No.: 16/317,104

(22) PCT Filed: Jul. 11, 2017
(86) PCT No.: PCT/GB2017/052025

§ 371 Date: Jan. 11, 2019

(30) Foreign Application Priority Data
Jul. 11, 2016 (GB) 1612017.2

(51) Int. Cl. F16L 11/127; F16L 11/02

(52) U.S. Cl. CPC F16L 11/127; F16L 25/026; F16L 11/02

(57) ABSTRACT

A fuel pipe having an elongate tubular body 12 of fiber reinforced composite material form, the material including a conductive material powder to render at least a part of the body of limited electrical conductivity, the tubular body 12 having a fitting 14 formed thereon or secured thereto to allow a part of the body 12 to be sealed to another component, wherein the fitting 14 is of an electrically non-conductive material.

This invention relates to a fuel pipe, and in particular to a fuel pipe of the type manufactured from a fibre reinforced composite material.

Composite material fuel pipes are well known. WO2009/087372 describes a fuel pipe manufactured from a suitable matrix material impregnated fibre composite material, the fuel pipe being designed for use in aerospace applications. By way of example, the material used may take the form of an electrically non-conductive reinforcing fibre, for example glass fibre, and an electrically non-conductive resin based matrix material. The pipe may by of multi-layered form, in which case the outer layer of the pipe, at least, may be of the form outlined hereinbefore.

Where used in aerospace applications, it is desirable for the fuel pipe to be of limited electrically conductive form, and this may be achieved through the addition of an electrically conductive powder material to the matrix material. The use of a pipe of limited electrical conductivity is advantageous in that it aids the dispersion of static charges. The conductivity is typically kept at a sufficiently low level that the fuel pipe would not serve as a primary conductor in the event of a lightning strike.

WO2009/087372 describes the addition of carbon black to the matrix material in order to increase the electrical conductivity of the fuel pipe. In the arrangement of WO2009/087372, the addition of the carbon black to the matrix material results in the outer layer of the fuel pipe having an electrical resistivity in the range of 50 kΩ to 4 MΩ per metre length thereof. Clearly, in such an arrangement, whilst the pipe is of electrically conductive form, it is only conductive to a limited degree and so may serve to dissipate static charges, but does not form a good enough conductor to serve as a primary conductor in the event of a lightning strike or in other circumstances.

The fuel pipe described in WO2009/087372 is provided at the ends thereof with a fitting formed with a groove in which an O-ring may be provided to allow the ends of the pipe to be connected in a fluid tight manner to other components of the fuel system. The fittings are typically of an electrically conductive material, for example being of metallic form.

Whilst the fittings allow the connection of the ends of the pipe in a fluid tight manner to other components of the fuel system, it has been found that the electrically conductive nature of these fittings tends to result in leaching of the carbon black from the pipe. This, in turn, forms a corrosive and abrasive paste which causes wear, in use, of the fittings and components to which the fittings are connected. As a result, the service life of such a fuel pipe may be unnecessarily reduced, both through the increased wear and through the leaching of the carbon black impacting upon the conductivity and other characteristics of the fuel pipe, and servicing and maintenance routines are of increased complexity as a consequence.

The nature of the seals formed between the fittings and the other components of the fuel system are typically such as to allow a degree of relative movement to occur therebetween, the O-rings or the like being arranged to form a limited sliding seal with the other components of the fuel system. As a result, thermal expansion and contraction, vibrations and other movements can be accommodated. The above mentioned paste arising from the leaching of the carbon black can cause damage to the seals, potentially resulting in fuel leaks.

Where O-rings of an electrically non-conductive material are used, then there may be a requirement to provide flying leads or the like to electrically connect the pipe to other components of the fuel system. This may be inconvenient.

It is an object of the invention to provide a fuel pipe in which at least some of the disadvantages associated with a known fuel pipe are overcome or are of reduced effect.

According to one aspect of the invention there is provided a fuel pipe comprising an elongate tubular body of fibre reinforced composite material form, the material including an electrically conductive material powder to render at least a part of the body of limited electrical conductivity, the tubular body having a fitting secured thereto or formed thereon to allow a part of the body to be sealed to another component, wherein the fitting is of an electrically non-conductive material.

By way of example, the presence of the electrically conductive material powder may result in the electrical resistivity of the pipe falling within the range of 50 kΩ to 4 MΩ per metre length thereof.

By avoiding the use of an electrically conductive fitting, the leaching effect mentioned hereinbefore is avoided. As a consequence, at least some of the disadvantages associated with the known arrangement described hereinbefore are overcome or are of reduced effect. The leaching effect is avoided without negatively impacting upon the electrically conductive characteristics of the pipe, and so it may still serve to dissipate static charges and the like.

The fibres of the fibre reinforced composite material are preferably of electrically non-conductive form, for example comprising glass fibres or a suitable electrically non-conductive polymer material.

The conductive material powder may comprise carbon black, for example. Alternatively, a different electrically conductive material powder may be used. By way of example, graphene may be used.

The fitting could take the form of a suitable electrically non-conductive plastics material moulding. Another option may be to use an electrically conductive material, such as aluminium or another material, provided with and encapsulated within an electrically insulating coating or sleeve. However, preferably, the fitting takes the form of an element fabricated from a suitable electrically non-conductive fibre reinforced composite material, the fitting being shaped to define a groove shaped to receive, in use, a seal member such as an O-ring or the like. It will be appreciated that the formation of the fitting may be undertaken as part of the process for manufacturing the remainder of the pipe, the fitting being manufactured using a matrix material that does not include the electrically conductive material powder. The fibres located within the fitting may be the same as those used elsewhere in the pipe, indeed they may form continuations thereof.

Conveniently, PTFE may be added to the reinforcing fibres of the fitting. The PTFE may be comingled with the fibres. The PTFE may serve as a lubricant for the O-rings or other seal members.

The fitting may be formed directly in the desired shape. However, it is envisaged that where the fitting is of wound fibre reinforced composite material form, the fitting will be machined to a desired shape and size to ensure that a good seal can be formed between the fitting and other component to which the fuel pipe is connected, in use.

According to another aspect of the invention there is provided a fuel pipe comprising an elongate tubular body of fibre reinforced composite material form, the material including an electrically conductive material powder to render at least a part of the body electrically conductive, the electrically conductive material powder comprising graphene.

The tubular body may have a fitting secured thereto to allow a part of the body to be physically connected and sealed to another component, wherein the fitting is preferably of an electrically non-conductive material.

According to a further aspect of the invention there is provided a fuel pipe comprising an elongate tubular body of fibre reinforced composite material form, the material including an electrically conductive material powder to render at least a part of the body electrically conductive, an end part of the body forming a connector flange to allow connection of the fuel pipe to another component, the fuel pipe including an integral bellows shaped section.

The presence of the bellows shaped section allows expansion, contraction or other movement to occur between the ends of the pipe whilst allowing the connector flange to be rigidly mounted upon the said another component. As the pipe is of limited electrically conductive form, and the flange is an integral part thereof, it will be appreciated that the need to provide flying leads or other electrical connectors between the pipe and the said another component is avoided as the mounting of the flange to the said another component can provide the required electrical connection therebetween. By way of example, bolts or the like used to mount the flange to the said another component may provide the electrical connection.

The invention will further be described, by way of example, with reference to the accompanying drawings, in which:

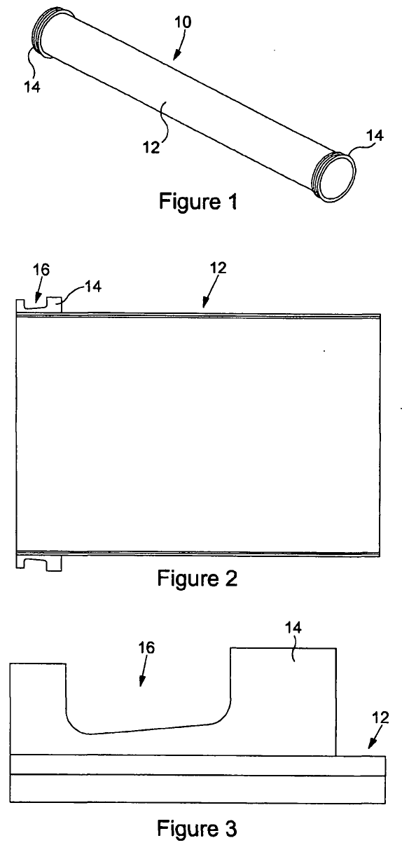

FIG. 1 is a diagrammatic view illustrating a fuel pipe in accordance with an embodiment of the invention;

FIGS. 2 and 3 are views illustrating part of the pipe of FIG. 1;

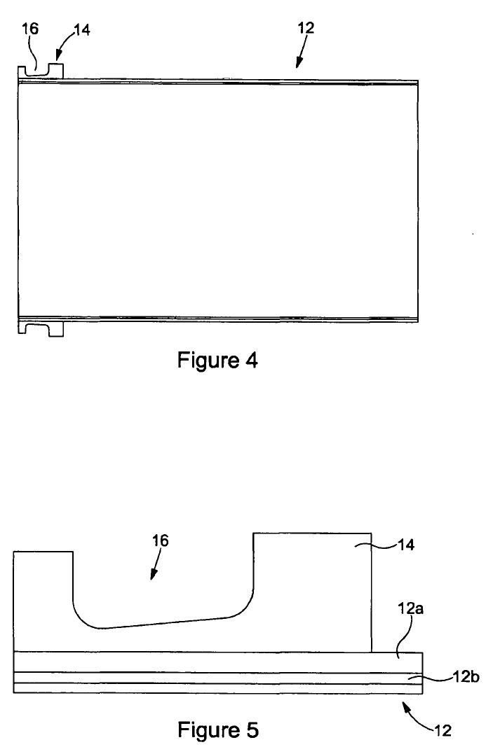

FIGS. 4 and 5 are views similar to FIGS. 2 and 3 but illustrating an alternative pipe; and

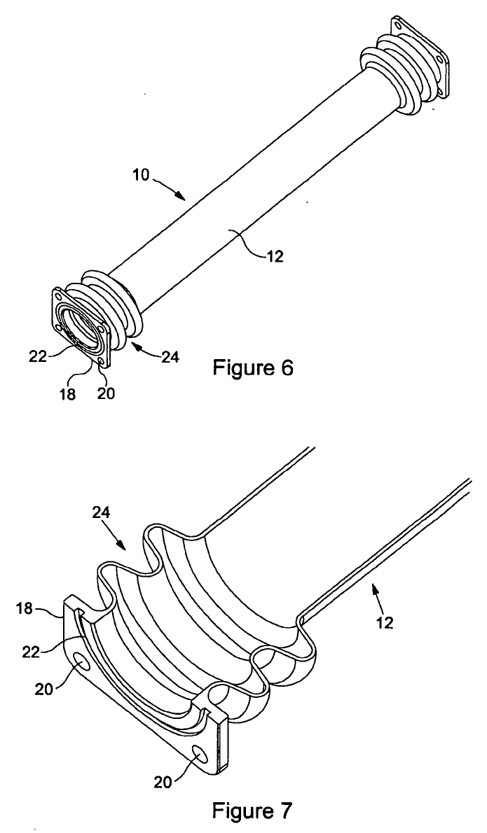

FIGS. 6 and 7 illustrate an alternative embodiment of the invention.

Referring firstly to FIGS. 1 to 3, a fuel pipe 10 is illustrated. The fuel pipe 10 takes the form of a body 12 of elongate tubular form. End fittings 14 are formed at the ends of the body 12. The body 12 is of a fibre reinforced composite material form. By way of example, it may take the form of glass fibres wound onto a mandrel during the manufacturing process, the fibres being impregnated with a suitable resin based matrix material. The glass fibres and the matrix material are both of electrically non-conductive form. In order to render the pipe 10 of limited electrically conductive form, the matrix material has an electrically conductive material powder added thereto. In this case, the electrically conductive material powder may take the form of carbon black. The proportion of carbon black added to the matrix material may be such as to render the electrical resistivity of the pipe 10 to fall in the range of 50 kΩ to 4 MΩ per metre length thereof as in the arrangement of WO2009/087372. However, it will be appreciated that this represents merely one example arrangement, and that other quantities of carbon black may be used without departing from the scope of the invention.

The end fittings 14 are of fibre reinforced composite material form, for example being formed of the same fibre as the body 12 impregnated with a suitable matrix material, for example the same matrix material as used in the body 12. However, the end fittings 14 are fabricated in such a manner as to be of electrically non-conductive form. Accordingly, no carbon black or other electrically conductive material powder is added to the matrix material used in the fitting 14. After curing, the end fittings 14 are machined to result in the fittings 14 taking a desired shape and being of desired dimensions. As illustrated, the fittings 14 are conveniently shaped or machined to form grooves 16 therein arranged to receive O-rings or the like to allow a limited sliding seal to be formed between the fuel pipe 10 and another component of a fuel system to which the pipe is connected, in use.

If desired, the fibres used in the fitting 14 may incorporate PTFE, for example PTFE fibres or filaments (either in the form of flocking or continuous filaments) may be comingled with the fibres during the winding process. The presence of the PTFE is advantageous in that it provides lubrication of the O-rings or the like located within the grooves 16.

It will be appreciated that the arrangement described hereinbefore is advantageous in that as the fitting 14 is of electrically non-conductive form, leaching of the carbon black or other electrically conductive material powder from the body 12 is avoided. Consequently, the risk of the formation of corrosive and abrasive paste that often occurs in typical arrangements is avoided. The damage caused by the formation of this paste is thus avoided, potentially leading to an increased service life and reduced servicing or maintenance requirements.

As shown, similar fittings 14 are conveniently formed as both ends of the pipe 10. However, this need not always be the case.

Whilst in the arrangement described, hereinbefore, carbon black is used as the electrically conductive additive, it will be appreciated that other materials such as graphene could be used instead, is desired.

FIGS. 4 and 5 illustrate an arrangement similar to that of FIGS. 1 to 3, but in which the body 12 is of multi-layered form, including an outer layer 12a and an inner layer 12b. By way of example, the inner layer 12b may be of electrically non-conductive form, just the layer 12a including the electrically conductive material additive. Such an arrangement may be advantageous in that the winding characteristics of the layers may be chosen to optimise the strength, flexibility and other parameters of the pipe. By only locating the electrically conductive material powder in one of the layers, cost savings may be made compared to arrangements in which the entirety of the body 12 contains the additive material. This may be especially advantageous where the electrically conductive powder material is relatively expensive. Other than as described hereinbefore, the arrangement of FIGS. 4 and 5 may correspond with that of FIGS. 1 to 3.

FIGS. 6 and 7 illustrate a fuel pipe 10 in accordance with another embodiment of the invention. In common with the arrangements described hereinbefore, the pipe 10 comprises a body 12 of fibre reinforced composite material, comprising electrically non-conductive fibres such as of glass or suitable polymer material form, impregnated with an electrically non-conductive resin based matrix material to which has been added an electrically conductive powder material such as carbon black, graphene or the like. As such, the pipe 10 may be of limited electrical conductivity as described hereinbefore.

At the ends of the pipe 10 are formed integral mounting flanges 18. In the arrangement shown, the flanges 18 are of generally square form, formed with openings 20 whereby the flanges 18 can be bolted or otherwise secured to other fuel system components. Each flange 18 further includes, on its outer face, an annular groove 22 arranged to receive a seal member to be clamped between the flange 18 and the other fuel system component to form a substantially fluid tight seal therebetween.

Where metallic bolts or the like are used to secure the flange 18 to the other fuel system component, then it will be appreciated that the bolts may provide an electrically conductive path between the material of the pipe 10 and the other fuel system components.

The body 12 is shaped to define a region 24 adjacent each flange 18 of bellows like form. It will be appreciated that the regions 24 allow limited flexing of the pipe 10, accommodating limited relative movement between the other fuel system components to which the pipe 10 is secured. The limited movement accommodated by the bellows shaped regions 24 may take the form of limited expansion or contraction of the length of the pipe 10 and/or limited bending thereof.

It will be appreciated that by providing the regions 24 to accommodate limited relative movement, there is no need for a sliding seal to be formed as in the arrangements described hereinbefore. Furthermore, there is no need to provide flying leads or the like (as may be required in the arrangements described hereinbefore) to establish an electrical connection between the pipe 10 and the other fuel system components.

Whilst specific embodiments of the invention are described hereinbefore, it will be appreciated that these merely represent examples and that a number of modifications, alterations or variants are possible without departing from the scope of the invention as defined by the appended claims.

1. A fuel pipe comprising an elongate tubular body of fiber reinforced composite material form, the material including an electrically conductive material powder to render at least a part of the body of limited electrical conductivity, the tubular body having a fitting to allow a part of the body to be sealed to another component, wherein the fitting is of an electrically non-conductive material.

2. A pipe according to claim 1, wherein the presence of the electrically conductive material powder results in the electrical resistivity of the pipe falling within the range of 50 kΩ to 4 MΩ per meter length thereof.

3. A pipe according to claim 1, wherein the fibers of the fiber reinforced composite material are of electrically non-conductive form.

4. A pipe according to claim 3, wherein the fibers comprise glass fibers or suitable electrically non-conductive polymer material fibers.

5. A pipe according to claim 1, wherein the conductive material powder comprises carbon black or graphene, or a mixture thereof.

6. A pipe according to claim 1, wherein the fitting takes the form of an element fabricated from a suitable electrically non-conductive fiber reinforced composite material incorporating an electrically non-conductive matrix material, the fitting being shaped to define a groove to receive, in use, a seal member such as an O-ring or the like.

7. A pipe according to claim 6, wherein PTFE is added to the reinforcing fibers of the fitting.

8. A pipe according to claim 7, wherein the PTFE takes the form of fibers or filaments comingled with the reinforcing material fibers.

9. A fuel pipe comprising an elongate tubular body of fiber reinforced composite material form, the tubular body having a fitting to allow a part of the body to be sealed to another component, wherein the fitting is of fiber reinforced composite form, PTFE having been added to the reinforcing fibers of the fitting.

10. A pipe according to claim 9, wherein the PTFE takes the form of fibers or filaments comingled with the reinforcing material fibers.

11. A fuel pipe comprising an elongate tubular body of fiber reinforced composite material form, the material including an electrically conductive material powder to render at least a part of the body electrically conductive, the electrically conductive material powder comprising graphene.

12. A fuel pipe comprising an elongate tubular body of fiber reinforced composite material form, the material including an electrically conductive material powder to render at least a part of the body electrically conductive, an end part of the body forming a connector flange to allow connection of the fuel pipe to another component, the fuel pipe including an integral bellows shaped section.

13. A pipe according to claim 1 where the fitting is formed on the tubular body.

14. A pipe according to claim 1 where the fitting is secured to the tubular body.
